(19) United States
(12) Patent Application Publication
(10) Pub. No.: US 2013/0332417 A1
(43) Pub. Date: Dec. 12, 2013

(54) Hybrid Client-Server Data Proxy Controller For Software Application Interactions With Data Storage Areas And Method Of Using Same

(71) Applicant: In Koo Kim, New York, NY (US)

(72) Inventor: In Koo Kim, New York, NY (US)

(21) Appl. No.: 13/911,116

(22) Filed: Jun. 6, 2013

Related U.S. Application Data
(60) Provisional application No. 61/657,380, filed on Jun. 8, 2012.

(51) Int. Cl. G06F 17/30

(52) U.S. Cl. CPC G06F 17/30115
USPC 707/613

(57) ABSTRACT

A method and system are disclosed for remotely monitoring and controlling traditional software application/computer program behavior through the use of a hybrid client-server data proxy controller (DPC). The client DPC intercepts application read/write/delete operations and relays the operations to the data storage area(s). Activity information is asynchronously sent to a server DPC in a remote computing environment where the monitored activity is recorded, analyzed, and application business logic is processed. The server DPC sends instructions back to the client DPC, whereby modifications to the client DPC behavior, software application, and data storage area can be made.

### CROSS REFERENCE TO RELATED APPLICATION(S)

This application claims the benefit of U.S. Provisional Application No. 61/657,380 filed Jun. 8, 2012, which is incorporated by reference as if disclosed herein in its entirety.

### FIELD OF THE DISCLOSURE

This disclosure relates to management of client/server computing environments, and more particularly to a system and method for remotely monitoring and affecting software application/computer program behavior through the use of a hybrid client-server data proxy controller (DPC).

### BACKGROUND OF THE DISCLOSURE

FIG. 1a schematically illustrates a traditional local computer operating system 10 where a software application 1 is executed and interacts with a data storage area (DSA) 2 (which may be either local or remote). Data is retrieved and saved through read, write, and delete operations onto a DSA such as database or file on a hard drive.

The local computer operating system provides access to services such as a file system, volatile memory, input/output devices, and network access and the software application utilizes those services to store and retrieve data on the DSA.

The DSA can reside in persistent memory as in the case of files residing on a file system or data inside a database; in volatile memory as in the case of data residing in the operating system RAM; or on a remote server as in the case of data retrieved from a web application through network protocols. The DSA can reside inside or outside the operating system. The DSA can also be a remote service such as an application server that provides storage and retrieval functionality.

### SUMMARY OF THE DISCLOSURE

Methods are disclosed to relay software application read/write/delete operations to data storage areas and asynchronously send data activity reports to a remote server environment where the monitored activity is recorded and analyzed. The remote server can then marshal instructions to a local client data proxy controller whereby modifications to application behavior and data storage area can be made.

In accordance with an embodiment of the disclosure, a system for implementing the method includes an application written in a computing environment that accesses information stored in a physical or abstract data storage area; a client data proxy controller (cDPC) to which read access and write/delete instructions are relayed from the software application to the data storage area; an optional memory cache; and a server data proxy controller (sDPC).

The application issues instructions to read/get, write/post, delete data in the data storage area. The application runs within a computer operating system which makes available standard resources such as networking, memory, and access to input and output devices. The data storage area is where data is stored and retrieved. The data can be stored in a persistent memory area as in the case of files residing on a filesystem or data inside a database; in a volatile memory area as in the case of data residing in the operating system RAM; or on a remote server as in the case of data retrieved from a web application retrieved through network protocols. The data storage area can reside inside or outside the operating system.

The cDPC acts as an intermediary interface for data storage and retrieval with the data storage area. Application activity with the data storage area is monitored and asynchronously reported to a remote server data proxy controller (see server data proxy controller description below) via network protocol. The cDPC executes instructions sent or retrieved from the server data proxy controller. The instructions can include read/write/delete operations to the data storage area and cache, changes to the local controller logic and protocols, or changes to the cDPC caching policy. The cDPC is a library/extension available to the software application or natively integrated into the software design. The software application in conjunction with the cDPC package forms the extended software application.

The optional memory cache can allow the cDPC to cache data from the data storage area locally on volatile memory to improve retrieval performance and/or reliability. In cases where the data is retrieved via network protocol from a remote application server, the cDPC can deliver cached content even when the data storage area is unavailable.

The server data proxy controller (sDPC) that receives application data access activity from the cDPC, applies business logic and computational resources to the received data, and sends instructions back to the cDPC to provide updates to the data storage area and cDPC configuration and controller logic. The sDPC requests are made asynchronously and access to the sDPC are not required for the cDPC to function. As the sDPC resides in a high profile server environment with intensive computational capabilities and access to extended data repositories, advanced operations such as Bayesian inference and artificial intelligence methodologies can be applied on the data access activity to create cDPC instructions that can affect an enhanced experience on the extended software application.

A method embodying the disclosure can typically be used within computer programs deployed on local computer operating systems such as smart phones, laptop computers, and workstations where computing resources are limited and/or access to remote server data, third-party content and services, or centralized program management facilities can extend the application capabilities.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1a schematically illustrates a local computer operating system interacting with data storage and where a software application is executed, as is understood in the art.

FIG. 1b schematically illustrates a system including hybrid data proxy controller (DPC) with a client DPC (cDPC) and a server DPC (sDPC), in accordance with an embodiment of the disclosure.

FIG. 2 schematically illustrates a system in which a client DPC, a data access layer, and a cache memory are grouped in a cDPC package, in accordance with an embodiment of the disclosure.

FIG. 3a schematically illustrates a cDPC implementation example for a read operation, in accordance with an embodiment of the disclosure.

FIG. 3b schematically illustrates a cDPC implementation example for a write operation, in accordance with an embodiment of the disclosure.

FIG. 3c schematically illustrates a cDPC implementation example for a delete operation, in accordance with an embodiment of the disclosure.

FIG. 4 illustrates an implementation for a data access layer, in accordance with an embodiment of the disclosure.

FIG. 5 illustrates an implementation for a memory cache, in accordance with an embodiment of the disclosure.

FIG. 6 illustrates an implementation for a server DPC, in accordance with an embodiment of the disclosure.

### DETAILED DESCRIPTION

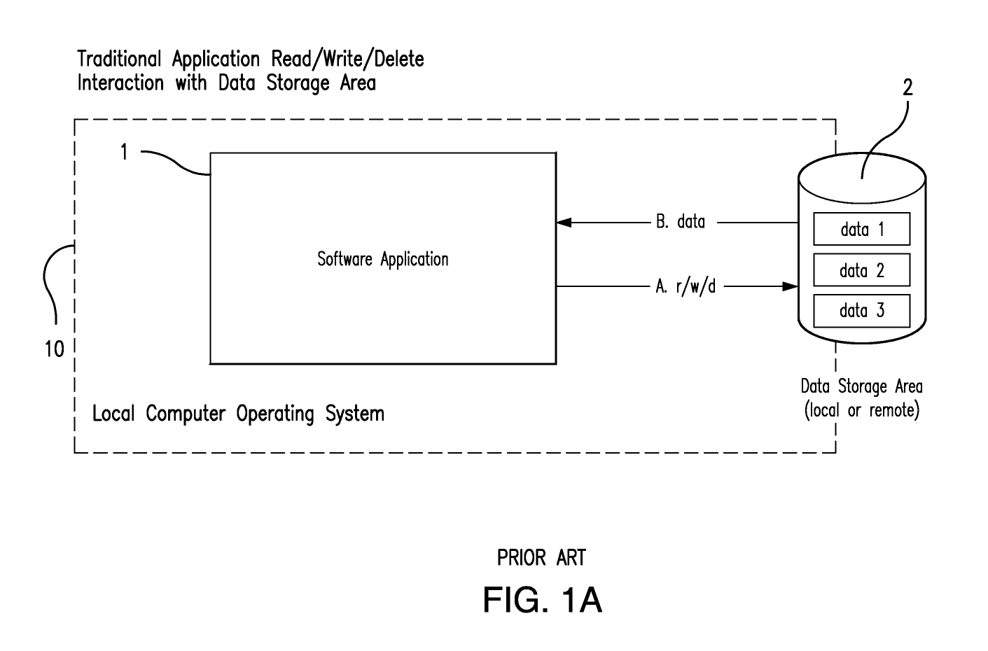

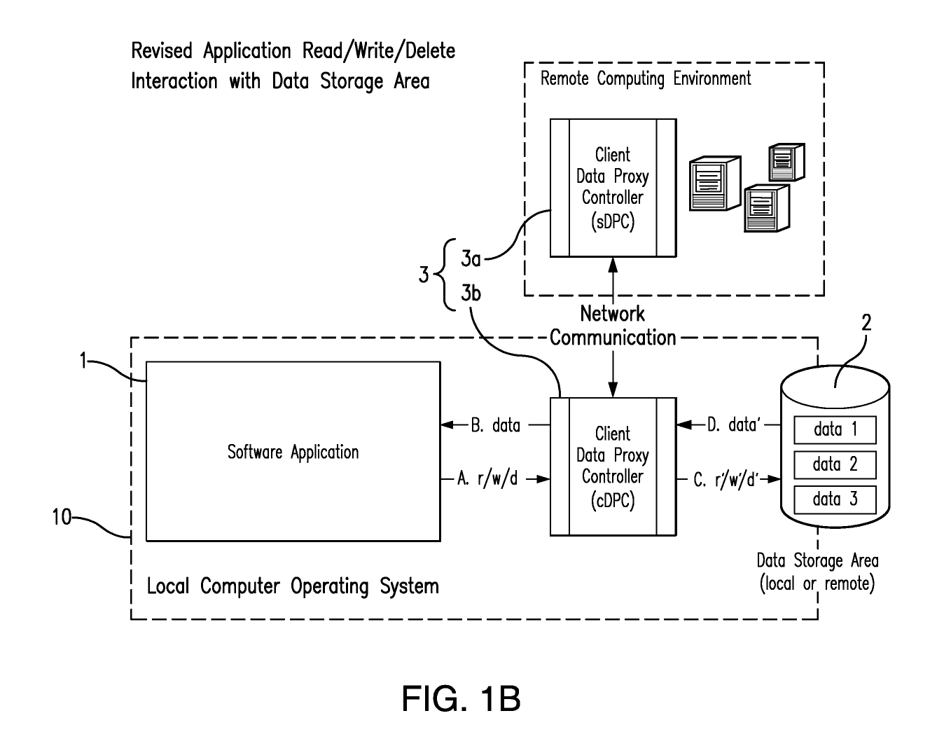

FIG. 1b schematically illustrates an embodiment of the disclosure, including a hybrid client-server data proxy controller (DPC) 3. The DPC is a type of “middleware”, acting as an intermediary agent between the software application 1 and the target data storage area 2. The DPC 3 intercepts a read/write/delete operation A from the software application 1 and marshals the operation to one or more DSA 2.

All application activity is proxied through the DPC 3; accordingly, information such as the application user's interest, intent, demographics, historical activity, etc. can be integrated with business logic and extended services to provide enhanced application capabilities. The DPC includes two parts: server DPC (sDPC) 3a and client DPC (cDPC) 3b.

The cDPC 3b is an agent that resides as an integrated middleware extension or library for the software application. The cDPC 3b acts as an intermediary interface for data storage and retrieval with the DSA 2.

The cDPC communicates application activity to the sDPC 3a, typically through secure asynchronous network protocols. In addition, the cDPC provides extended capabilities such as caching, and executes business logic. The cDPC also receives instructions from the sDPC and executes those instructions within the local application.

The sDPC 3a is a program running on a remote server that receives activity information from the cDPC. This information is stored and analyzed. The sDPC provides a centralized management facility for cDPC activity for programs running on multiple devices. Upon analysis and business logic evaluation, cDPC instance specific (for an application on a specific device) or global cDPC instructions (for an application on multiple devices) are created. These instructions are sent by the sDPC to the cDPC (push) or retrieved by the cDPC from the sDPC (pull) via network protocols. The instructions can include modifications to the DSA 2, direct instructions to the software application 1, or instructions that affect the DPC behavior or internal configuration.

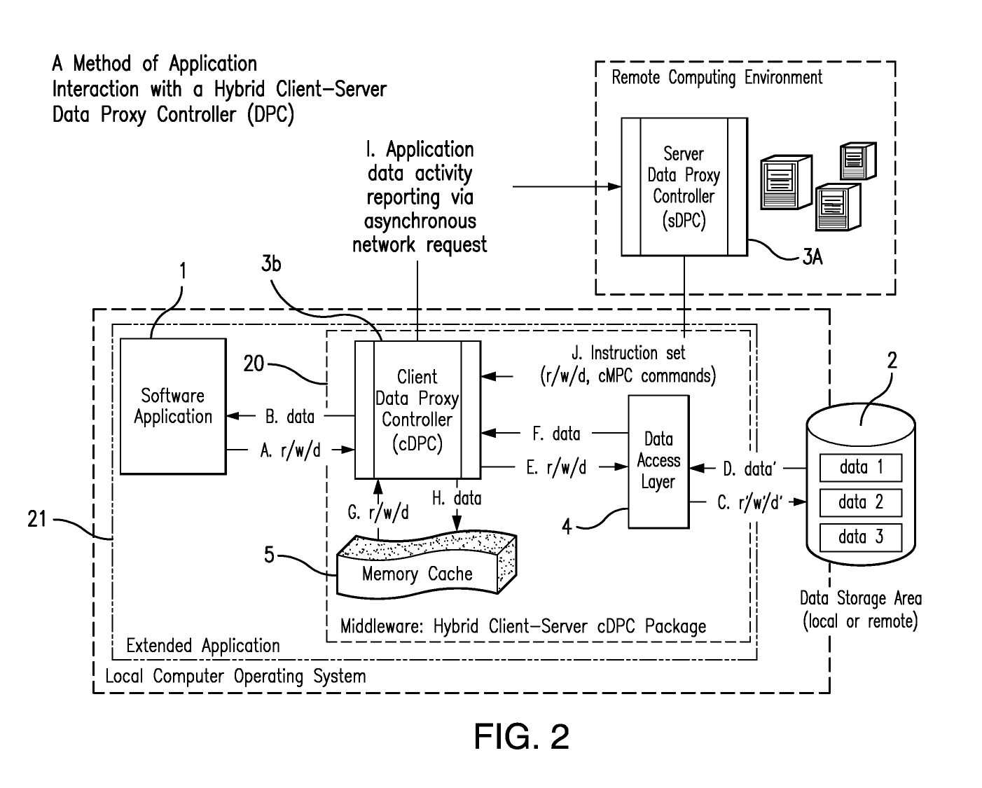

To provide a separation of concern and enhance performance and stability within the cDPC 3b, the middleware library/extension can be integrated with a memory cache 5 and data access layer (DAL) 4, as shown in FIG. 2. In this embodiment, the cDPC 3 b, memory cache 5, and DAL 4 are grouped as a cDPC package 20. The cDPC 3b in FIG. 2 acts to process incoming read, write, delete operations from the software application and decides how to handle the operation based on programmed logic.

The memory cache 5 is typically a fast and volatile allocation of memory where application read and write operations can be temporarily stored and retrieved based on a caching policy. The cache and the caching policy can be modified by the cDPC with instructions from the sDPC to optimize application performance, stability, and data access even in cases where the DSA may not be accessible (e.g. loss of network communications to an application server when cellular signals are disrupted).

The DAL 4 translates read, write, and delete operations to different types of data storage areas. Read, write, and delete operations A are proxied from the software application 1 through the cDPC interface into the DAL 4. The incoming operation E is then transformed into operations C recognized by the target DSA. Conversely, data responses D from the DSA are transformed inside the DAL into data formats F that are consistent with the cDPC data interface. The data B is then sent to the software application by the cDPC.

The cDPC package 20 and software application 1 form an extended application 21 that can be modified through instructions from the sDPC.

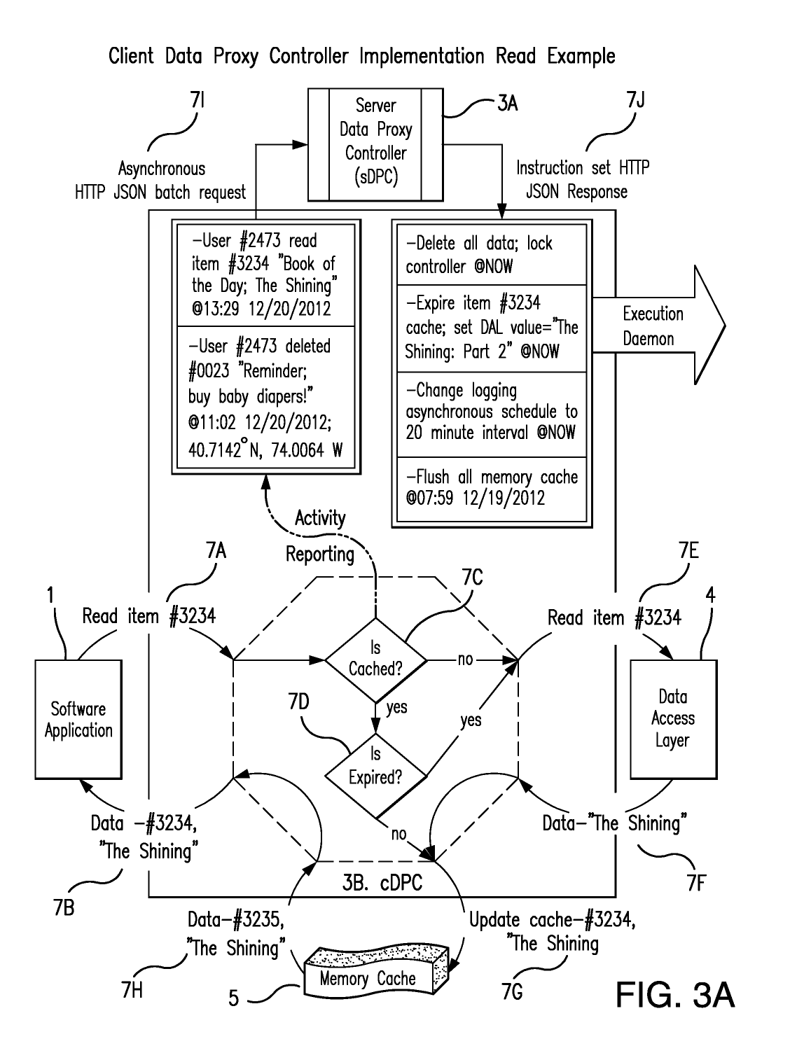

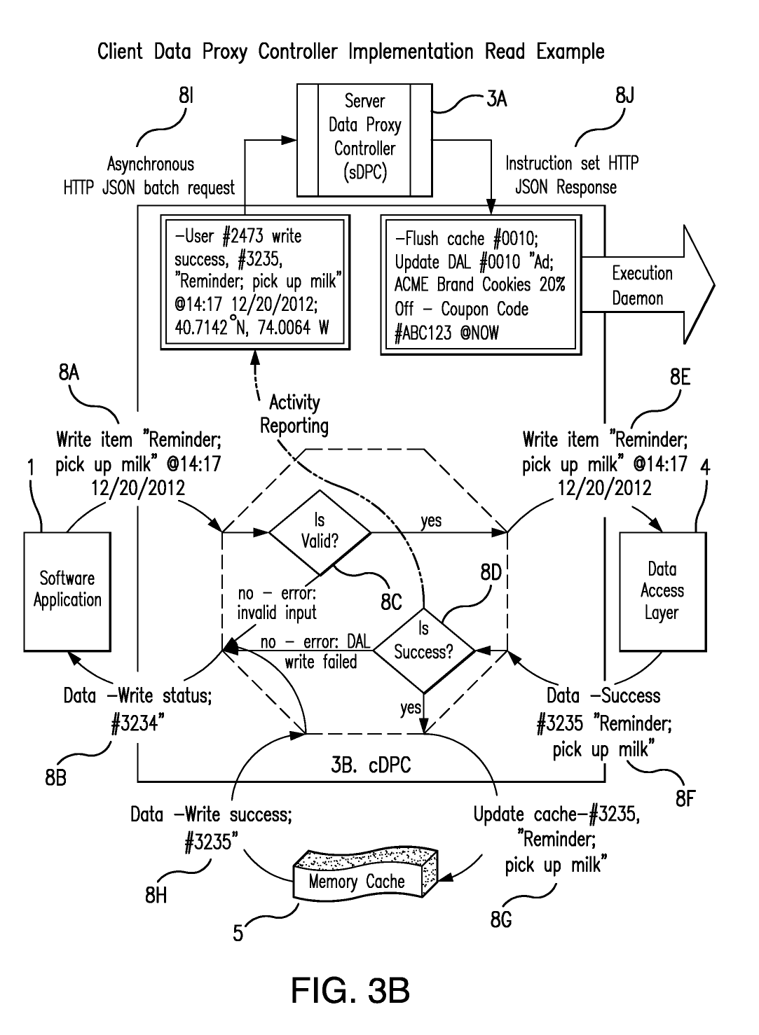

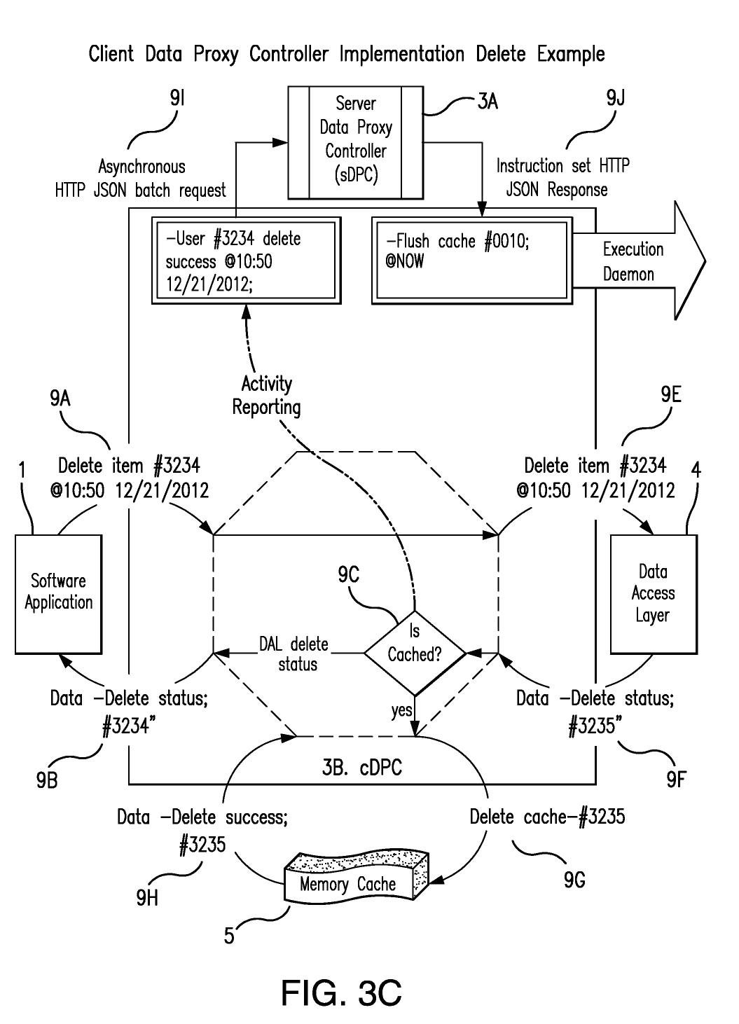

FIG. 3a illustrates a cDPC implementation example for a read operation, showing the steps performed therein. In FIG. 3 a, the software application 1 issues a read operation in step 7A from the cDPC for a data object (for example, “The Shining” with key #3234). The cDPC queries the memory cache 5 and checks in step 7C if the item is cached. If not, the operation is forwarded in step 7E to the DAL 4. If it is cached, then the memory cache is queried in step 7D to see if the item is expired based on the caching policy. If it is expired, then the operation is forwarded in step 7E to the DAL 4. If the cached data item is not expired, then the operation is retrieved in step 7H from the memory cache 5 and returned in step 7B to the software application 1. The data resulting from read operations is sent in step 7F to the DAL 4 and retrieved from the data storage area, “The Shining”, updated in step 7G into the memory cache according the caching policy, and returned in step 7B to the software application 1.

The read activity, along with other batched activity information is asynchronously sent in step 71 to the sDPC. The sDPC issues an instruction set in step 7J that includes one or more instructions to the cDPC, including an instruction to update content within the DSA to expire item key #3234 from the memory cache and update a new value “The Sinning 2” for the key into the DSA.

FIG. 3b illustrates an implementation example for a cDPC write operation, showing the steps performed therein. A write operation, for example a reminder to buy milk, is sent in step 8A from the software application 1 to the cDPC 3b. The write content is validated in step 8C. Invalid data that is non-conformant to the cDPC write interface is returned with a write error status. Valid data is forwarded in step 8E to the DAL 4 where it is then stored into the DSA 2. The write operation in step 8F is checked in step 8D whether it was successful. A successful DSA write operation is updated in step 8G into the cache based on its key, and returned in step 8B to the software application with a write operation status (provided in step 8H). An invalid DSA write operation is returned with an error status.

The write activity is sent in step 81 to the sDPC. In this example, the sDPC analyzes geo-location information along with the “milk” keyword and sends an instruction in step 8 J to the cDPC to update an application advertisement area with key id #0010 with a relevant coupon for “Acme Brand Cookies 20% Off” at a store located near the application user.

FIG. 3 c illustrates a cDPC implementation for a delete operation, showing the steps performed therein. In this example, a delete operation for item with key #3234 is sent in step 9A to the cDPC where it is relayed in step 9E to the DAL. Upon successful delete of the item from the DSA in step 9F, the memory cache is checked in step 9C. If the delete item exists in cache, the item is deleted in step 9G. A return status (provided in step 9H) is sent to the software application in step 9B.

Activity for the delete operation is sent in step 91 to the sDPC 3a. The sDPC determines that the “Acme Cookies” advertisement is no long relevant and an instruction is sent in step 9J to delete the ad from the application.

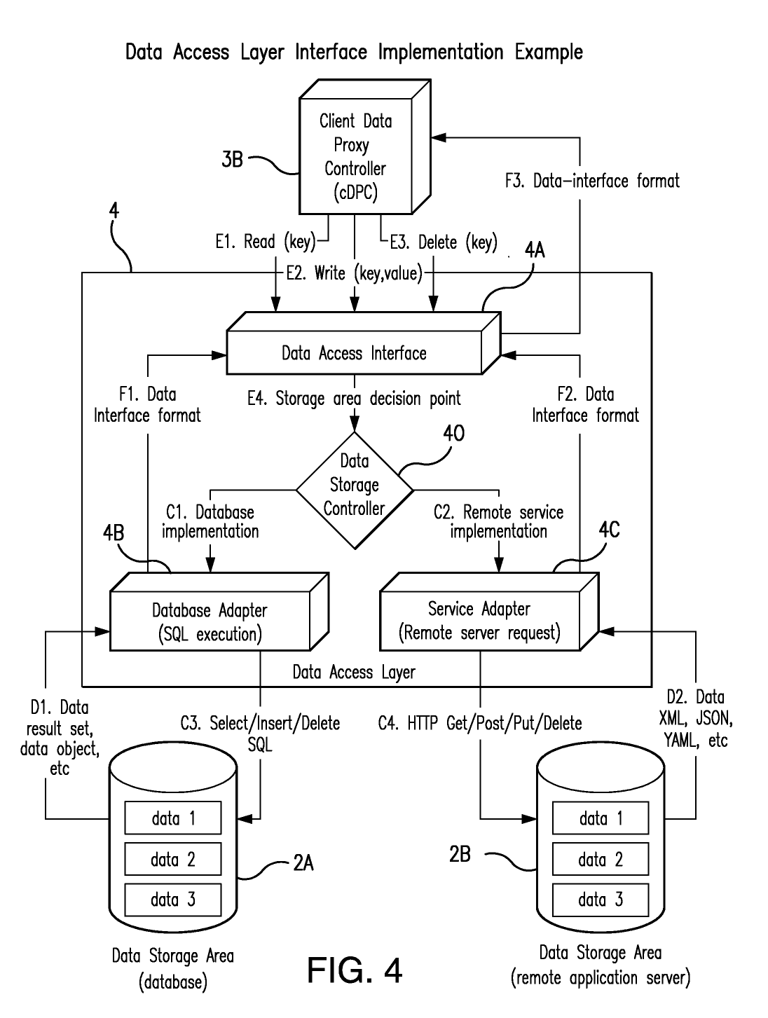

FIG. 4 illustrates an implementation for a data access layer. In this embodiment, the DAL includes a data access interface 4a, a database adapter 4b, a service adapter 4c, and a data storage controller 40. The DAL 4 receives data modifications and retrieves data from the data storage area 2 while isolating the cDPC from the implementation details of the DSA.

The DAL receives read/write/delete operations from the cDPC according to the cDPC interface, and provides an implementation to one or more persistent data storage areas 2a and 2b. (In this embodiment, DSA 2a is a database local to system 10, while DSA 2b is at a remote application server.) The target data storage area is determined by the data storage controller 40. This controller can be modified by instructions from the sDPC. For example, the data storage controller can be configured to retrieve ad content from a third party ad serving engine located on a remote application server, while content core to the application can be retrieved from a local database through SQL.

By insulating the cDPC from the DSA implementation details, application complexity is reduced and ad-hoc DSAs can be defined and added dynamically by the cDPC (via instructions from the sDPC) without the need to modify the application.

Further, the DAL can translate the return data from different DSAs into a consistent format consistent with the cDPC interface format. In addition to simplifying data access and storage, the interface enables the cDPC to monitor data access activity in a consistent way.

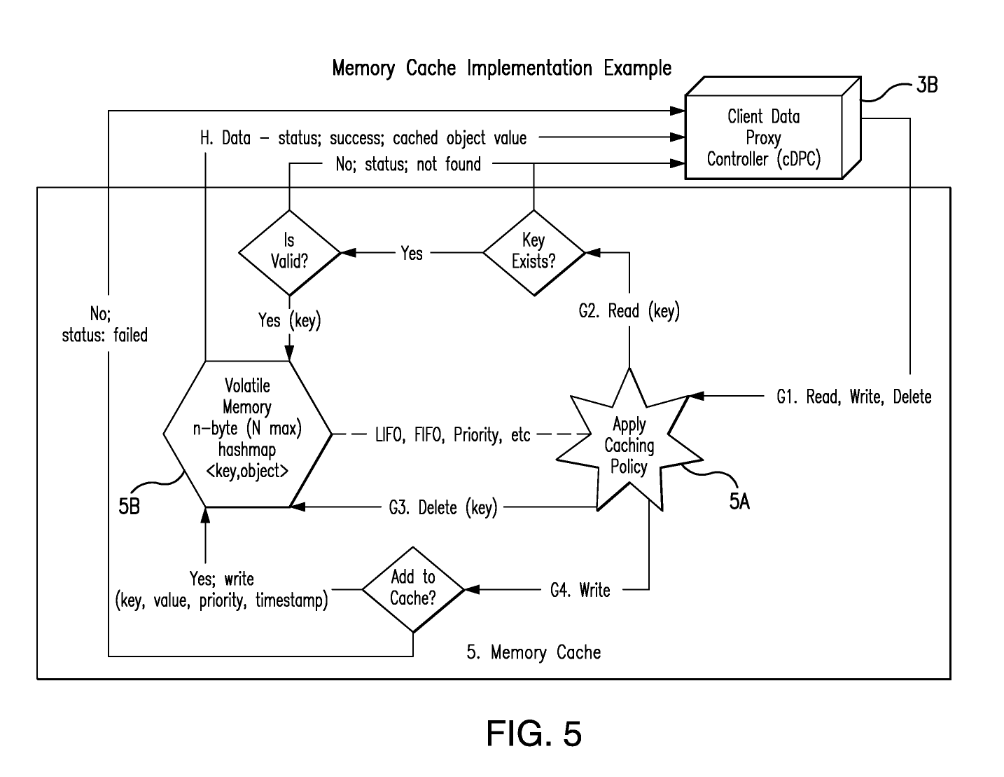

In an embodiment, as shown in FIG. 5, a memory cache can allow the cDPC to cache data from the data storage area locally on volatile memory to improve retrieval performance and/or reliability.

In cases where the data is retrieved via network protocol from a remote application server, the cDPC can deliver cached content even when the data storage area is unavailable.

In cases where the data is stored on a persistent memory store (typically much slower than volatile RAM memory), the cDPC can deliver cached content with improved speed.

The caching policy defines the configuration and logic used to determine whether or not a data write should be stored in the cache based on the available memory. It also determines the expiration of cached content and whether or not read operations should be delegated to the DAL or returned directly from the cache. Some common caching policies are LIFO (last in, first out), FIFO (first in, first out), Priority (priority rank based expiration), and combinations thereof. The caching policy can also be a custom application specific policy that is sensitive to specific data keys and values.

The cache (and the DAL) is not required for the cDPC to function; but rather, should be viewed as an example of how the cDPC can be packaged with other functional elements to enhance the application.

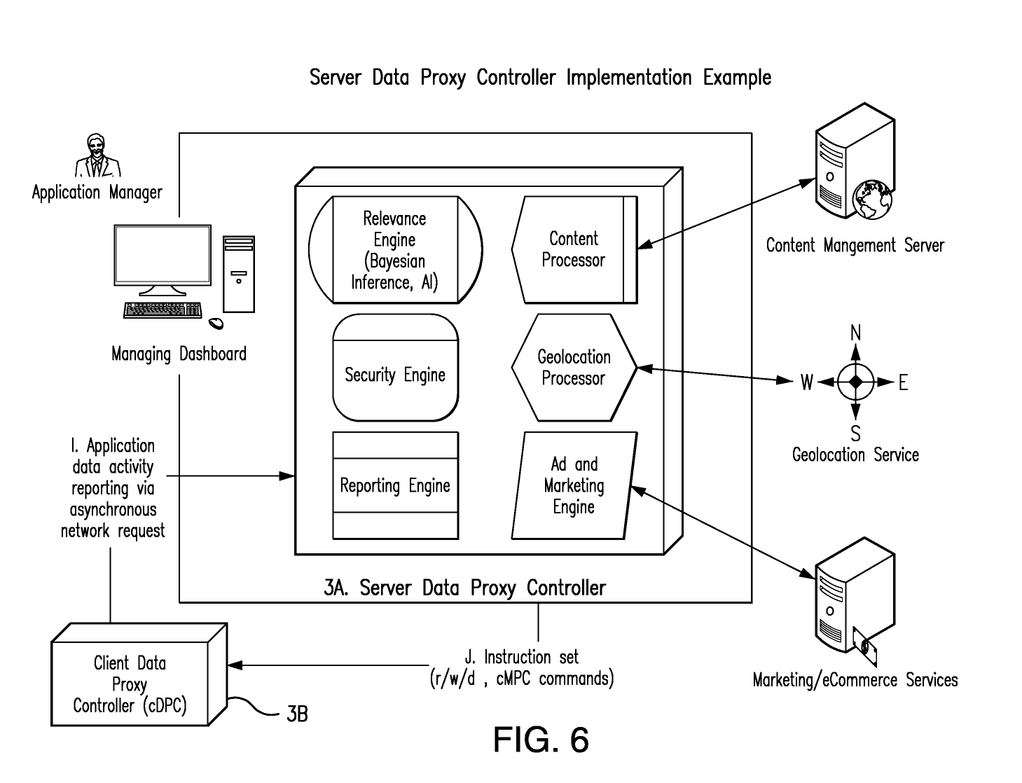

FIG. 6 illustrates an example of implementation of a server data proxy controller (sDPC). In FIG. 6, the sDPC receives application data operation activity from the cDPC. The sDPC applies business logic and computational resources to the received data and sends instructions back to the cDPC.

The instructions provide updates to the data storage area, as well as cDPC package configuration, cDPC controller logic, and application behavior. Requests to the sDPC are made asynchronously and continuous connection to the sDPC are not required for the cDPC to function. This is important so that the cDPC not act as a bottleneck for application performance or stability.

As the sDPC resides in a high profile server environment with intensive computational capabilities and access to extended data repositories, advanced operations such as Bayesian inference and artificial intelligence methodologies can be applied on the application data access activity to create cDPC instructions that can affect an enhanced experience on the extended software application.

The sDPC provides an interface for users such as application managers and DPC administrators to monitor application activity, create instructions, and configure application behavior.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

What is claimed is:

1. A system comprising:
an application in a computing environment, accessing information stored in a physical or abstract data storage area;
a client data proxy controller (cDPC) to which read instructions, access instructions and write/delete instructions are relayed from the software application to the data storage area;
optional memory cache, DAL, and likewise ancillary components of the cDPC package; and
a server data proxy controller (sDPC) to which cDPC data activity is asynchronously sent and processed;
whereby instructions are then returned to the cDPC to affect application behavior.
